(19) United States
(12) Patent Application Publication
(10) Pub. No.: US 2015/0177851 A1
(43) Pub. Date: Jun. 25, 2015

(54) USER INPUT ERROR DETECTION AND CORRECTION SYSTEM

(71) Applicant: N Sringeri OMPRAKASH, Karnataka (IN)

(72) Inventor: N Sringeri Omprakash, Karnataka (IN)

(21) Appl. No.: 14/412,211

(22) PCT Filed: Jul. 3, 2013
(86) PCT No.: PCT/IN2013/000410

§ 371 Date: Dec. 31, 2014

(30) Foreign Application Priority Data
Jul. 3, 2012 (IN) 2677/CHE/2012

(51) Int. Cl. G06F 3/023; G06F 17/27

(52) U.S. Cl. CPC G06F 3/0237; G06F 17/276

(57) ABSTRACT

In one embodiment of the present invention, error caused while typing a character or key in a key board is detected using a neighborhood vicinity table. A neighborhood vicinity table contains the list of neighboring key values for each key on the keyboard. As a results the error detection and correction is performed by considering both neighborhood key statistics table and an appropriate language dictionary or a context details. As a result, error caused due to close proximity of the key are corrected. In other embodiment, speed of the input key pressed is measured to detect the simultaneous pressing of two or more key. The detected error is notified to the user as soon the speed is found to exceed the threshold. Further, the simultaneous key pressing error is considered while providing error corrections.

### CROSS REFERENCES TO RELATED APPLICATIONS

This application claims priority from International PCT application No. PCT/IN2013/000410 filed on Jul. 03, 2013, which in turn claim priority from Indian patent application No. 2677/CHE/2012 filed on Jul. 03, 2012. Both applications are incorporated herein in its entirety by reference.

### BACKGROUND

1. Technical Field

Embodiments of the present disclosure relate generally to the computer systems and more specifically to user input error detection and correction system.

2. Related Art

A computer system often receives user input through various means such as keyboard, mouse, voice interface, fingerprint detector, smartcard, and such other mechanisms. Often user may make an error while providing the input to the computer systems. An entry made by the user is considered as an error depending on the application that the user is working with. For example, if user is working on a word processor which is set to detect a language error according to a pre-specified dictionary, the word processor may consider a word input by the user as an error if the word is not present in the dictionary.

In one prior word processor, the error is detected and the possible corrections are proposed to the user for adoption. In another prior word processor user may set auto correct options that automatically corrects the word in error to closest correct word in the dictionary.

In prior embodiments, the error detection and correction are dependent on the application that is running in the computer system. Hence an entry made by user is considered an error in one application while other application may not detect or correct the same error. In one prior implementation an error detection and correction is implemented as a macro that are used by multiple applications running in the computer system.

### SUMMARY

In one embodiment of the present invention, error caused while typing a character or key in a key board is detected using a neighborhood vicinity table. A neighborhood vicinity table contains the list of neighboring key values for each key on the keyboard. As a results the error detection and correction is performed by considering both neighborhood key statistics table and a appropriate language dictionary or a context details. As a result, error caused due to close proximity of the key are corrected.

In other embodiment, speed of the input key pressed is measured to detect the simultaneous pressing of two or more key. The detected error is notified to the user as soon the speed is found to exceed the threshold. Further, the simultaneous key pressing error is considered while providing error corrections.

### BRIEF DESCRIPTION OF DRAWINGS

The present invention will be described with reference to the following accompanying drawings.

FIG. 1 is a block diagram of an example computer system.

The FIG. 2 is a flow diagram depicting the manner in which typing error may be detected and corrected according to present invention.

FIG. 3a through 3h is the example text editor in embodiment of the present invention.

FIG. 4a through 4d illustrates two ways of error occurring as user types on keyboard.

FIG. 5a through 5d illustrates how the word is autocorrected when the neighboring keys are pressed without notifying user.

FIGS. 6a and 6b illustrates simultaneous keys pressed condition and auto corrected before the word is typed completely.

FIG. 7a through 7d illustrates the alternative scenario where system remembers the simultaneous key pressed condition and corrects the error after the set of inputs received.

FIG. 8 is a block diagram illustrating the manner in which the error detection and corrections are implemented in the computer system.

### DETAILED DESCRIPTION

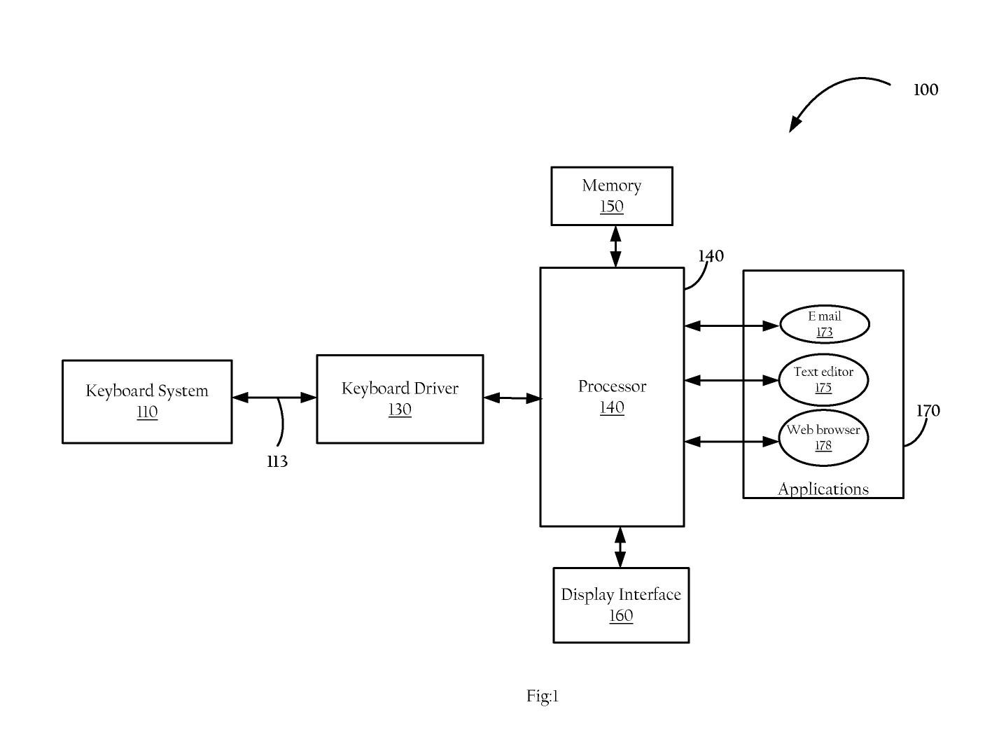

FIG. 1 is a block diagram of an example computer system in which various aspect of present invention may be implemented. Computer system 100 is shown containing Keyboard system 110, Keyboard Driver 130, Processor 140, Memory 150 Display Interface 160 and Applications 170. Each block is described below in further detail.

The keyboard system 110 is a peripheral device comprising number of keys that receives user input about a key pressed and sends the details (example a scan code) of the key pressed to keyboard driver 130 as well known in the art. Key pressed may represent alphanumeric character or other special functions as designed and implemented on the key board. In general, special functions are performed by pressing a key specifically designed for such special functions or by pressing one or more key simultaneously as well known in the art.

Key board may be structured to receive mechanical pressure or impact from the user to detect the user input. Alternatively, key board may be further implemented as touch screen, feather touch and other methods to receive the user intended inputs. Typically the key boards are implemented based on the size of the device on which it is being built, for example in case of PDA, mobile phones, smart phones the keyboards are built small and may require a additional tool (such as stick) or skill to press the key accurately. The keys are arranged in a particular fashion that is globally accepted and used. As a result the user may press the keys based on the relative position without looking at the keyboard. Key board system may be implemented to interface with the CPU through key board driver 130. The path 113 may be implanted as wireless or wire line paths using applicable standards and protocols such as PS/2, USB, Bluetooth, WLAN etc. accordingly corresponding interface supporting circuitry and software may be implemented within the Keyboard system 110.

Keyboard driver 130 receives the details of the key pressed (Scan code) from the Key board system 110 and converts the information or data into desired format suitable for the application running on the CPU 140. In general, one driver may be used for multiple applications to depict the common usage of the key board across the application. For example an alphanumeric keyboard may have a common driver across all the application while an additional driver may convert each key to a particular piano tone for digital piano application. The computer system 100 recognizes connected keyboard system 110 through key board driver 130.

Processor 140 executes software instructions or programs to perform desired functionality. Processor may execute more than one instruction in a parallel fashion. Processor may interface with peripheral devices, keyboards, display system through appropriate drivers. Processor 140 may be implemented using one or more processer cores or more than one processor connected in a network.

Processor 140 generally contain Arithmetic Logic Unit (ALU) for performing computations, registers 142 for temporary storage of data and instructions and a control unit 143 for controlling the operation of the computer system in response to the instructions from a computer program such as an application or an operating system. ALU (Arithmetic Logic Unit) 141 is the part of a computer that performs all arithmetic computations, such as addition and multiplication, and all comparison operations. CPU 140 is comprised of a discrete ALU 141, registers 142 and control unit 143 or may be a single device in which one or more of these parts of the CPU 140 are integrated together, such as in a microprocessor. Moreover, number of arrangements of the elements of the computer system may be varied from what is shown and described in ways in the art. A processor register 142 is a small amount of storage available as part of a CPU 140 or other digital processor. Such registers are (typically) addressed by mechanisms other than main memory and can be accessed more quickly. The number of registers that a CPU has and the size of each (number of bits) help determine the power and speed of a CPU. For example a 32 bit CPU is one in which each register is 32 bits wide. Therefore, each CPU instruction can manipulate 32 bits of data. The control unit of the CPU 140 contains circuitry that uses electrical signals to direct the entire computer system to carry out stored program instructions. The control unit 140 does not execute program instructions: rather, it directs other parts of the system to do so. The control unit 140 must communicate with both the arithmetic logic unit and memory. The ALU, Control unit, and registers all together refer to as processing unit. As is well known in the art the processors are built using multiple core processing units capable of processing multiple instructions simultaneously. Further, though only one CPU unit is depicted in the figure, the CPU 140 may comprise multiple processing units. Each processing units may run programs in parallel as tasks or threads or sequentially by assigning the priority to each task.

The memory system 150 generally includes high speed main memory in the form of a medium such as Random Access Memory (RAM) and Read Only Memory (ROM) and the secondary storage in the form of a medium such as floppy disks, hard disks, tape, CD-ROM etc. and other devices that use optical, magnetic or other recording material, Main memory stores program such as a computer's operating system and currently running application programs.

Display 160 provides visual display to users. Display 160 may be implemented using one or more of CRT, LCD, LED and other display technologies. The size resolution and technology of the display may be suitably selected to integrate on various user devices such as personal desktop computers, laptops, PDA, mobile phones, etc., and the applications the devices being used.

Applications 170 are shown containing Email, web browsers, text editors etc. each application is stored as programs in memory 150. Applications 170 when executed by CPU 140, receives user input through the keyboard 110 and perform various functions. Each application prints the alphanumeric character (input by user) on a display screen to enable user to determine the key pressed. Some of the applications that generally prints the user typed (input by the user) characters are email applications (while composing an email), web browser (while filing an on line form or searching on the web) and a text editor/word processor (while editing a document).

Often, the user may press a key that is not intended by him due to closely placed keys in the Keyboard or use of different key boards at different time. In some application such mistakes are highlighted only when complete word is typed. In one prior embodiment, the completed word is compared with pre-defined set of words (dictionary) in a particular or desired language to detect error and correct error. Thus, corrects common typographical error, spelling errors, expand abbreviations and/or typing short cuts and can correct the pronunciation of word or phrase.

However, the various mistakes while pressing the key boards are not detected and provided as a feedback to user for correction or to perform auto correct. Manner in which errors made on the key boards may be detected and corrected according to various aspect of the present invention is described below with reference to FIG. 2.

The FIG. 2 is a flow diagram depicting the manner in which typing error may be detected and corrected according to present invention. The flow begins in step 201 and control passes to step 210.

In step 210, computer system 100 receives a sequentially more than one character or entry through keypad from the user. Computer system may receive input sequentially through keyboard and keyboard driver. Input may be considered sequential when received at a a rate not less than a preset value. For example, two inputs may not be considered as sequential if the time gap between the inputs is greater than few seconds. Further special keys that are designed to perform special functions may be considered as sequential. Further, computer may determine end of sequence when a particular key is pressed for example “enter” function keys that are placed distinctly away from the alphanumeric keys.

In step 220, computer system 100 determines the speed of arrival of sequentially received inputs/characters. The detection of simultaneous key pressed is determined by calculating the typing speed of the normal human being. Speed of arrival of the inputs may be determined at the key board driver by incorporating speed detection instructions or may be implemented within an application. Speed detection may be performed by using a system internal clock. For example number of clocks elapsed between two successive interrupts generated by the keyboard driver or key board interface may determine the speed of arrival of the inputs.

In step 230, computer system 100 checks if speed is above a threshold, if yes control passes to step 240 else to step 250. Considering a normal human can type 150 words per minute (wpm). Then for typing one letter the user takes approximately 120 msec which may be set as threshold. If two or more inputs are sequentially received at speed greater than the threshold set (120 ms) computer system concludes as an error.

In step 240, computer system 100 notify user of possible error in the user input. Alternatively, the computer system may correct the error without notifying the user. Notification may be provided using various means such as audio, pop up window, flashing the screen etc. as an alternative approach; the error may be corrected without notifying the user there by not hindering the working speed of the user.

In step 250, computer system 100 determines a logical end in the sequentially received inputs forming a set of inputs. Computer system may determine the logical end of the sequence based on some of the inputs (key pressed) such as “enter”, Space Bar, or any other keys pre-determined by the application/s. further, computer system may also determine end of sequence when no input is received for long time period (undue delay). Sequence of inputs received till determination of end of sequence is referred to as set of sequentially received inputs or (a word).

In step 260 computer system 100 checks for error in set of sequentially received inputs. If error is determined to be present control passes to step 270 else passes to step 299. computer system may check for error in the set of inputs by comparing the word with a dictionary (or a context reference that defines the condition in which the inputs are being made and checks if the inputs are within the context of the application) of a desired language. Further, the dictionary may also refer to any natural language database and natural language correction system having its own data base for reference. If the word exists in the dictionary, the computer system determines as no error. Else it decides as an error.

In step 260, Autocorrect by referring to a neighborhood vicinity table or a dictionary. Computer system refers to neighborhood vicinity table and selects one of the letters in the neighborhood list for replacement. The letter is selected such that the word formed by replacement is present in the dictionary of choice.

In step 299, the flow is terminated (End). Manner in which error detection and correction is performed in an embodiment is further described with reference to a example text editor. However, one skilled in the art may adapt the technique to other applications by reading the disclosure provided herein.

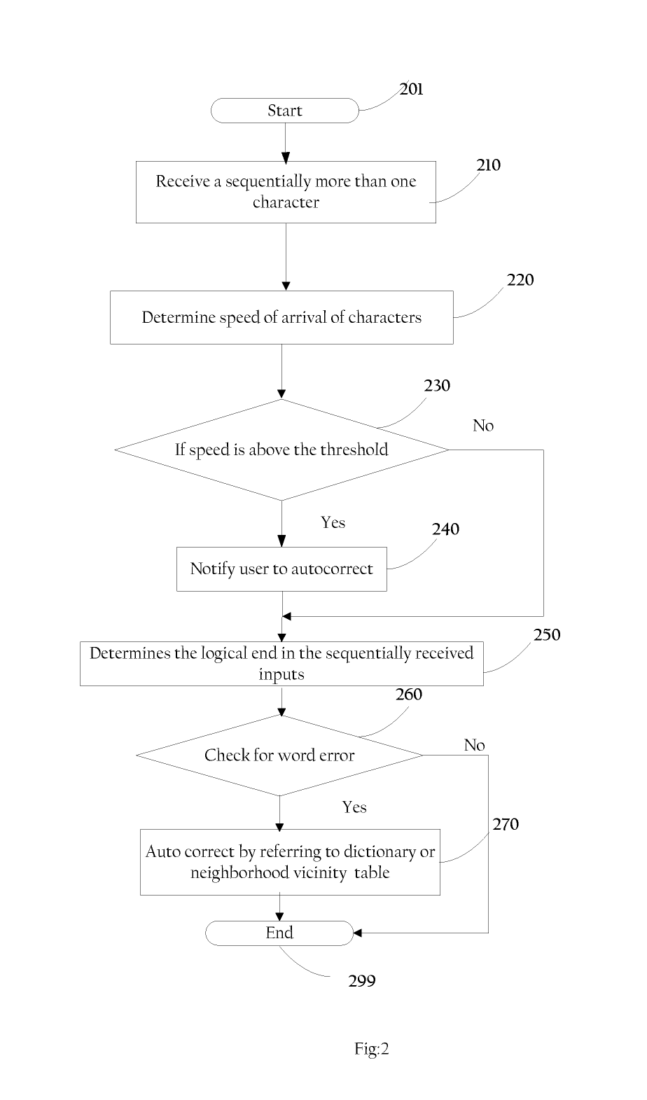

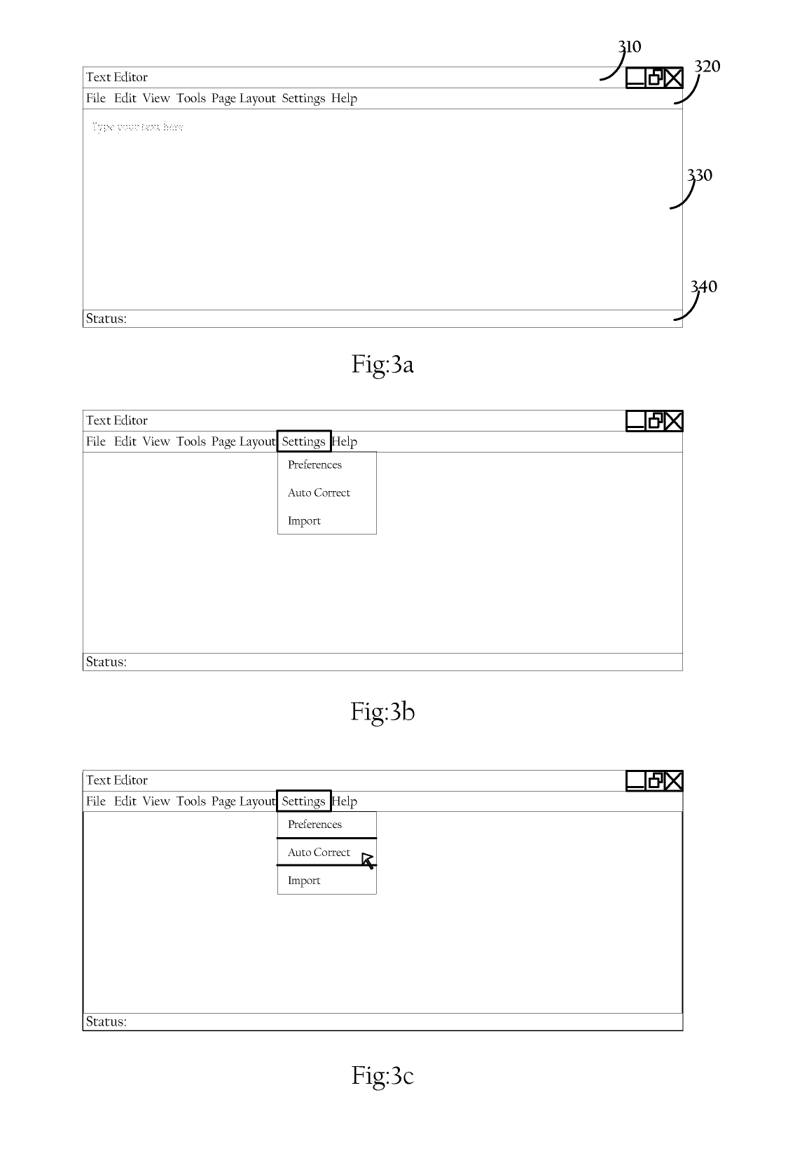

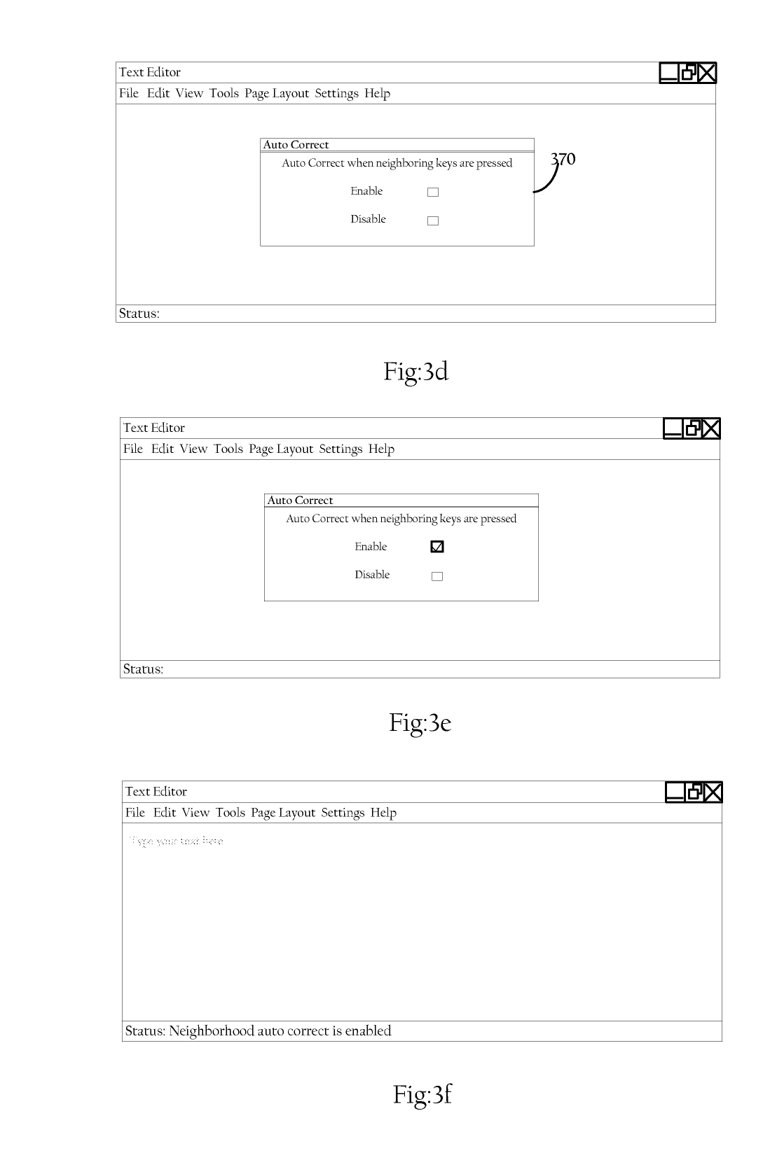

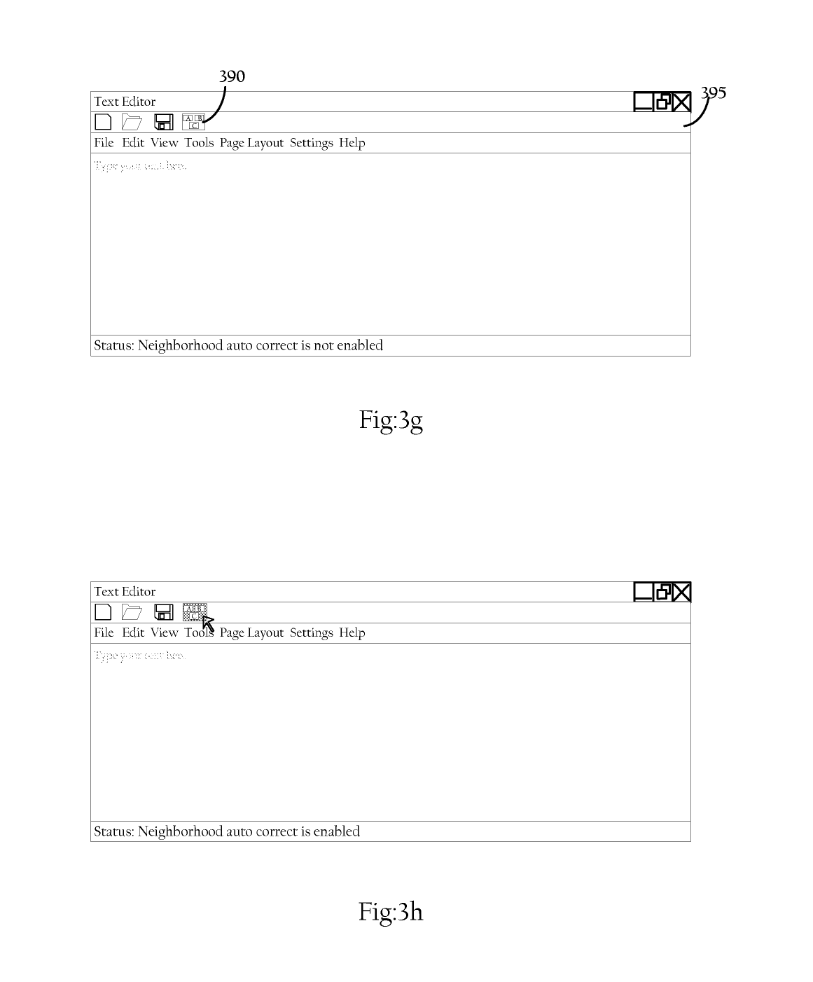

FIG. 3a through 3h is the example text editor in embodiment of the present invention. The example text editor is shown comprising title bar 310, menu bar 320, a plain text screen 330 to type text and a status bar 340 to display the current status. FIG. 3b through 3f illustrates manner in which the editor may be configured to perform error detection and correction of the user inputs. User selects “settings” option (as shown in FIG. 3b) from the menu bar 320 and selects auto correct option (as shown in FIG. 3c). When an auto correction option is selected by the user, dialog box 370 appears on the screen. The dialog box is shown providing two options “Enable” and “Disable” to user. User may select check box against the option “Enable” to enable the Neighborhood auto correct. Once user selects check box against “Enable”, the example text editor is configured to perform the error detection and correction according to present invention.

FIGS. 3g and 3h illustrates alternative way of configuring example text editor to perform error detection and correction according to present invention. As shown there, the sample text editor is shown containing an icon 390 on tool bar 395. User may click on the icon 390 to configure or enable error detection and correction feature. In FIG. 3h, icon 390 is shown (turn) grey indicating error detection and correction feature is enabled. In order to disable error detection and correction feature, user again clicks on the icon 390. The icon turns white when the feature is disabled (as shown in FIG. 3g). Example errors that may be caused when user sequentially inputs the data is described below with reference to example keyboard.

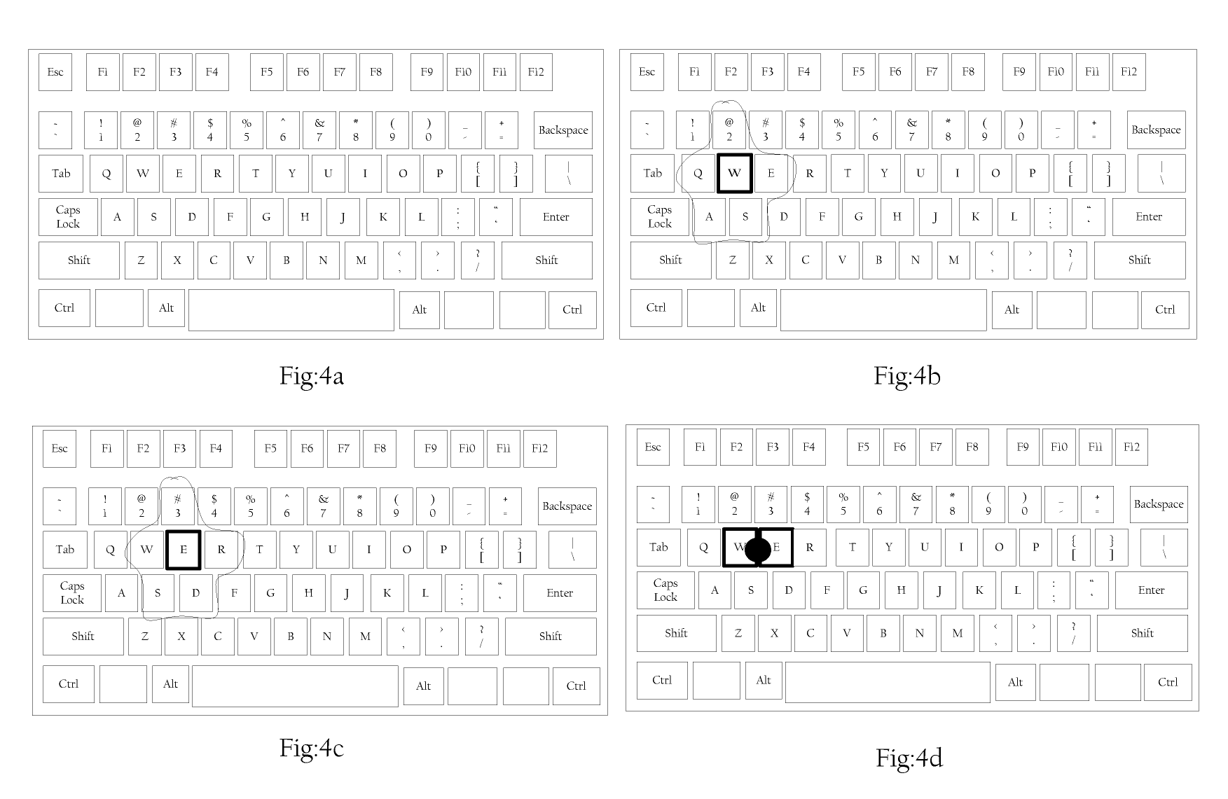

FIG. 4a is an example keyboard layout which shows the placement of keys on the keyboard. Description is continued with an example scenario where user intend to input letter “w” and actually inputs letter “e”. Accordingly FIG. 4b illustrates all the neighboring key of the letter “w”. Thus it is likely that a user may press one of the neighboring keys “q”, “a”, “s”, “e”, “3” and “2” due to close proximity or other issues such as use of different keypads at different times etc. The description is continued with the scenario where user has pressed key “e” (one of the neighboring key) instead of letter “w”. FIG. 4c illustrates the list of neighboring keys of letter “e” and same is stored in the memory/database for referencing. Thus similar list may be maintained for all the keys as “neighborhood vicinity table” in the memory for referencing.

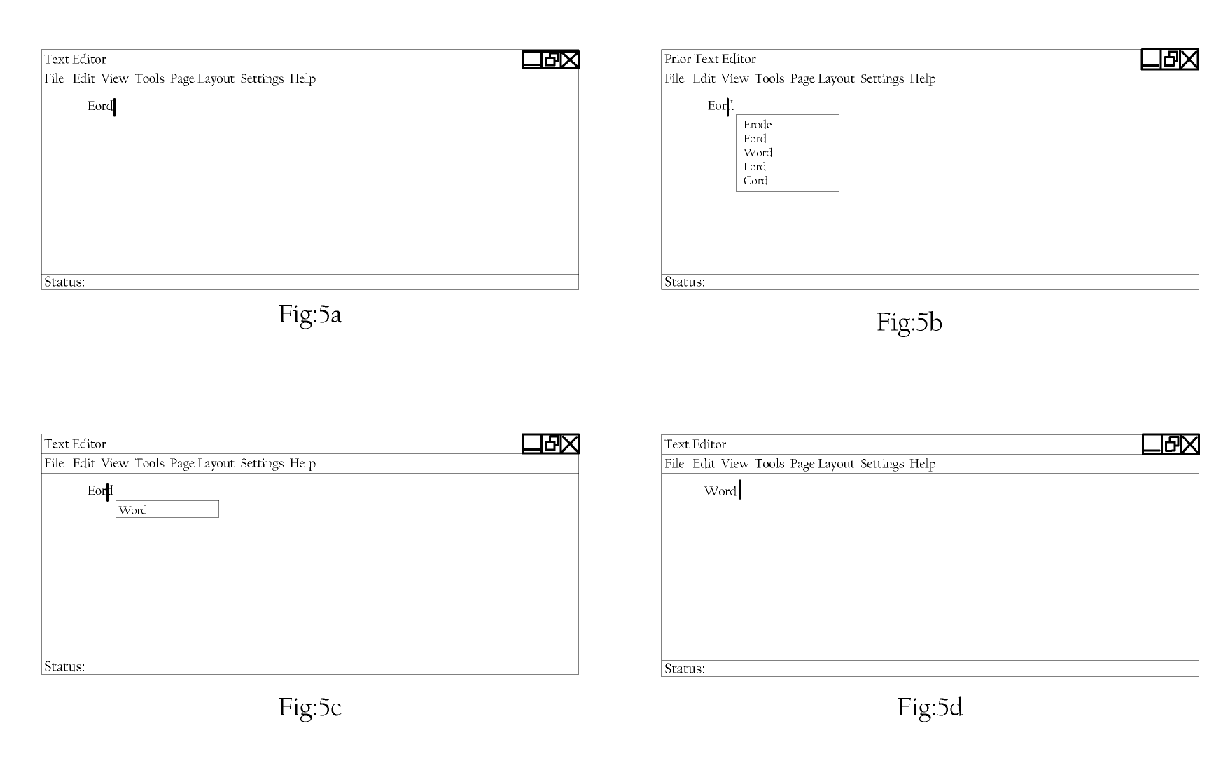

FIG. 4d illustrates another example of error that user may make. As shown there, user is shown inputting two inputs (press two keys) simultaneously. In the example, the letter w and e are shown pressed simultaneously. Manner in which the error described with reference to FIG. 4a through 4d may be corrected is described below with reference to FIG. 5a through 5d.

FIG. 5a is an user interface of an example editor depicting a condition where a set of four words are input to the computer system by the user and letter “w” is wrongly input as letter “e”.

FIG. 5b illustrates the option provided to user in one prior word processor. As shown there the prior word processor provides options for correction based on the entries in the referenced dictionary.

FIG. 5c illustrates the option provided in an example embodiment of the present invention. As shown there, Computer system refers to the neighborhood vicinity table of letter e and finds “w” to match with both in vicinity table and dictionary entry thus provide one option “word” as shown in FIG. 5c. Alternatively, computer system may check with dictionary to find first shortlist of possible words. Then, computer system may refer to vicinity table to further filter the options.

FIG. 5d illustrates the how the sequence of input is corrected without notifying user as only one option is present in this scenario. Considering the FIG. 5c, due to two level filtering, the only option “word” may be replaced to “eord” without notifying the user. As a result, by using the technique disclosed in these inventions, at least in some occasions, the error may be detected and corrected more accurately and effectively. Manner in which error due to simultaneous pressing the key may be reduced effectively is illustrated below.

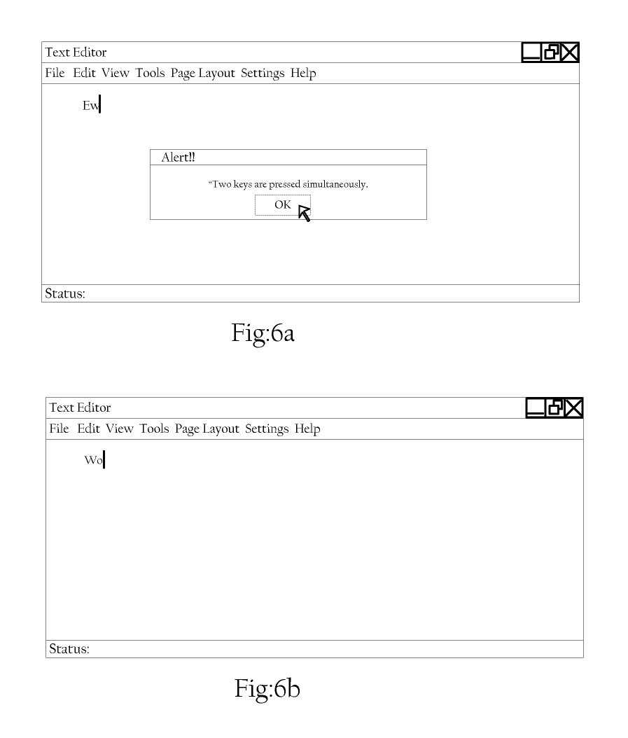

FIG. 6a illustrates simultaneous input of two letters, in this case, two letters “e” and “w” are determined to be received at speed greater than the threshold (example 120 miliseconds). As a result computer system determines the entry as error and notifies user of the error caused before end of input sequence. For example computer system does not wait for completion of sequence (word) to detect and correct error. Instead, computer system detects and tries to correct error by notifying the user as soon it detects simultaneous input condition.

FIG. 6b illustrates the manner in which the error is corrected automatically without user intervention. As seen here, the combination letter “ew” is determined to be error as they are received at a speed greater than the threshold. As soon a third letter in the sequence is received, the computer checks for the combination “ewo” and finds “wo” to be more appropriate and replace “ew” with “w”.

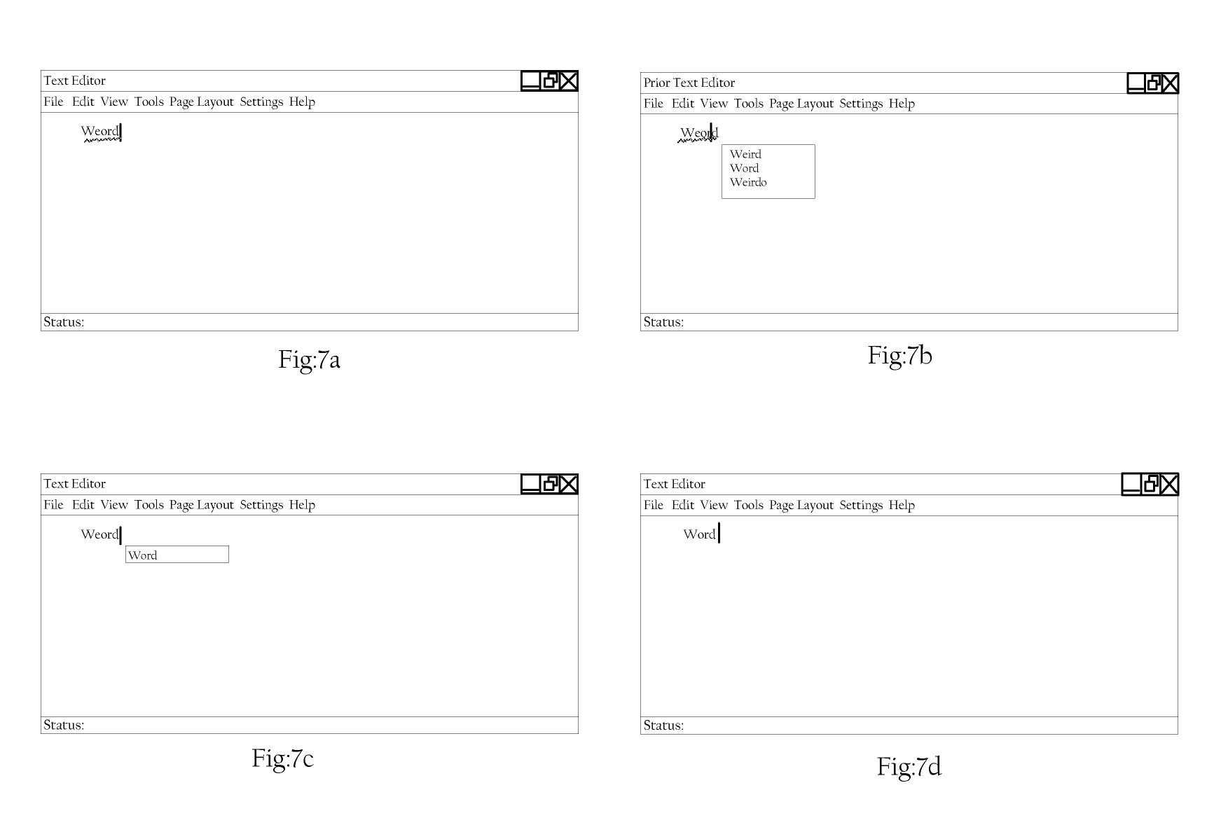

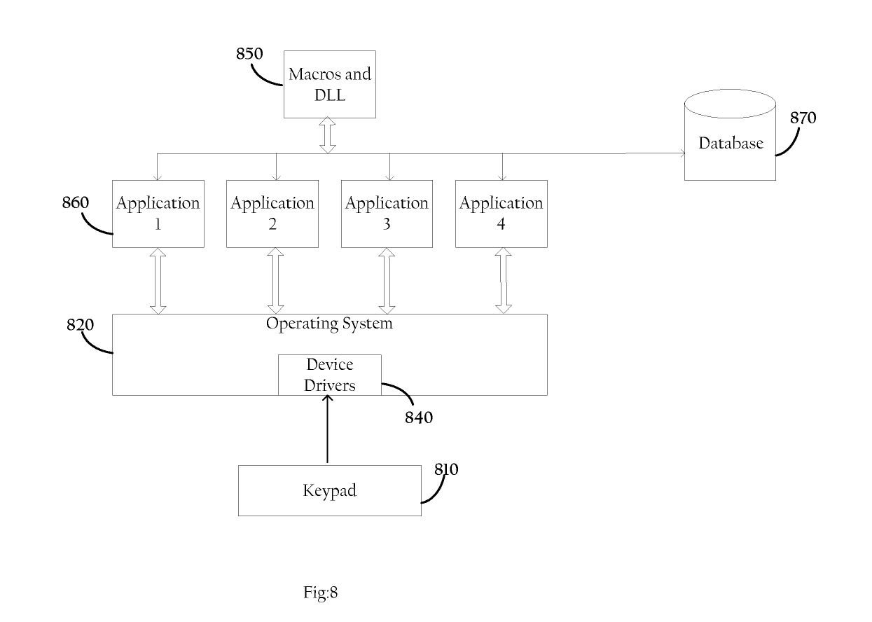

FIG. 7a illustrates the alternative scenario where system remembers the simultaneous key pressed condition and corrects the error after the set of inputs received. As shown there, the user has input the set of characters “Weord”. Computer has determined that first two letters “we” were received at speed greater than threshold.

FIG. 7b illustrates an option provided in a prior text editor. As shown there the prior text editor has provided multiple options that are close to word “weord”

FIG. 7c illustrates an option provided to user according present invention. Since computer system has already determined the error in the first two letters, only one option “word” is presented to user instead of three or more.

FIG. 7d illustrates manner in which the error is autocorrected without user intervention. As shown in the figure, computer system directly replaces the error word “weord” with correct option “word” without notifying the user.

Manner in which various aspect of the present invention may be implemented in a computer system is illustrated with reference to FIG. 8.

FIG. 8 is a block diagram illustrating the manner in which the error detection and corrections are implemented in the computer system. The block diagram is shown containing keypad 810, operating system 820, drivers 840, macros and DLLs 850, applications 860, database 870. Each block is described below in further detail.

Device driver receives the user inputs and provides user input to the operating system. Operating system forwards the input received to the appropriate application that is active. Applications may interact with DLLs and macro to execute special functions and operations. Operating system manages the execution of driver, applications and DLL. In one embodiment, the speed of the input is determined by the driver. The driver then sends both user input and speed information to the application through Operating System. In an alternative embodiment, application may make use of DLLs and Macros to determine the speed of input sequence or the speed determine functionality may be built inside the application.

Database 870 stores the neighborhood vicinity table and also the dictionary of appropriate language. In an alternative embodiment, the dictionary may be maintained by the application memory and the application may also load the vicinity table temporarily to the application memory for fast comparison. The dictionary and vicinity table may be stored in a various format such as HTML, sql, java script and/or any other suitable format for processing and accessing. The application may be built to perform the functionalities as described in the above sections.

Though the description is provided with reference to text editor the concept may be extended to other applications and editing scenarios. By reading the disclosure provided herein for example, the error detection and correction techniques may be employed in various programming editors as well wherein the referencing for error correction may be made to the syntax library rather than the language library as described above for example when an error is detected the computer system may first identify the nearest applicable set of inputs (word) from a syntax library of a programming language followed by the number of options obtained from the syntax library may be further filtered using neighborhood vicinity table.

While various embodiments of the present disclosure have been described above, it should be understood that they have been presented by way of example only, and not limitation. Thus, the breadth and scope of the present disclosure should not be limited by any of the above-described embodiments, but should be defined only in accordance with the following claims and their equivalents.

What is claimed is:

1. A method comprising:
receiving a sequence of characters through a keypad layout;
determining an error in the sequence of the characters; and
replacing a first character in the sequence with a second character that is in vicinity of the first character in the keypad layout,
wherein replacing the first character with second character eliminates the error in the sequence of characters.

2. The method of claim 1, wherein the sequence of character represent a word and the error is non-availability of the word in a dictionary.

3. The method of claim 1, further comprising:
determining a time duration between receiving the first character and the second character consecutively; and
removing the second character from the sequence when the time duration is less than a threshold,
wherein the threshold representing a condition of unintentional activation of two keypads in the keypad layout.

4. The method of claim 1, further comprising:
maintaining a vicinity table comprising list of characters in vicinity of each keypad; and
obtaining the second character from the vicinity table.

5. The method of claim 4, further comprising:
comparing the sequence of characters with a dictionary to form a first set of closest matching words;
comparing the sequence of characters with the vicinity table to form a second set of closest matching words;
replacing the sequence of characters with a word present in both first set and the second set.

6. A computer device comprising:
a keypad layout configured to receive sequence of characters;
a first processing part configured to determine an error in the sequence of the characters;
a second processing part configured to replace a first character in the sequence with a second character that is in vicinity of the first character in the keypad layout to form an error free sequence of characters; and
a display configured to print the error free sequence.

7. The computer device of claim 6, wherein the sequence of characters represent a word and the error is non-availability of the word in a dictionary.

8. The computer device of claim 7, further comprising a first memory configured to store a vicinity table comprising list of characters in vicinity of each keypad wherein the second character is obtained from the vicinity table.

9. The computer device of claim 8, wherein the first processing part comprises a first processor coupled to first part of a second memory and the second processing part comprises the first processor and a second part of the second memory.

10. The computer device of claim 9, further comprising a third processing part configured to:
determine a time duration between receiving the first character and the second character consecutively; and
removing the second character from the sequence when the time duration is less than a threshold,
wherein the threshold representing a condition of unintentional activation of two keypads in the keypad layout.

11. A mobile device comprising:
a keypad layout configured to receive sequence of characters wherein the sequence of character represent a word;
a first memory configured to store a vicinity table comprising list of characters in vicinity of each keypad wherein each keypad in the keypad layout representing a character;
a second memory configured to store sequence of instructions;
a first block configured to determine an error in the sequence of the characters wherein the error is non-availability of the word in a dictionary;
a third processing part configured to determine a time duration between receiving a first character and a second character consecutively and removing the second character from the sequence when the time duration is less than a threshold;
a second block configured to replace the first character in the sequence with the second character that is in vicinity of the first character in the keypad layout to form a error free sequence of characters; and
a display configured to display the error free sequence.
